(19) United States
(12) Patent Application Publication
(10) Pub. No.: US 2012/0046931 A1
(43) Pub. Date: Feb. 23, 2012

(54) MULTIPLE POWER-SUPPLY SIMULATION RESULT ANALYZER AND METHOD OF ANALYZING THE SAME

(75) Inventors: Hiroshi Takahashi, Osaka (JP); Shinsuke Honma, Kanagawa (JP); Kazushi Hayashi, Osaka (JP); Kazuyuki Ike, Osaka (JP)

(73) Assignee: PANASONIC CORPORATION, Osaka (JP)

(21) Appl. No.: 13/287,653

(22) Filed: Nov. 2, 2011

Related U.S. Application Data
(63) Continuation of application No. PCT/JP2010/000797, filed on Feb. 9, 2010.

(30) Foreign Application Priority Data
May 12, 2009 (JP) 2009-115457

(51) Int. Cl. G06F 17/50

(52) U.S. Cl. 703/15

(57) ABSTRACT

In a method of displaying a waveform of a simulation result, a waveform file extractor which extracts information of voltage values in addition to simulation times, values, and signal names input as waveform information, and a waveform display unit which enables a display of the wave information with the voltage values added are included. Thus, when a waveform of a multiple power-supply simulation is displayed on a display, voltage information is displayed together with the waveform, thereby allowing the voltage information to be analyzed together with a change in value at each simulation time. Thus, efficient analysis is achieved.

### CROSS-REFERENCE TO RELATED APPLICATION

This is a continuation of PCT International Application PCT/JP2010/000797 filed on Feb. 9, 2010, which claims priority to Japanese Patent Application No. 2009-115457 filed on May 12, 2009. The disclosures of these applications including the specifications, the drawings, and the claims are hereby incorporated by reference in its entirety.

### BACKGROUND

The present disclosure relates to an apparatus and method for circuit verification, and more particularly to multiple power-supply simulation result analyzers and methods of analyzing the same for efficient verification of logic circuits designed with multiple power supplies.

Conventionally, analysis using a waveform is widely used as a method for analyzing a circuit or a test bench described in a hardware description language (HDL), such as Verilog HDL or VHDL. Waveform viewers have also been widespread as analysis tools used for such analysis. For example, presently popular waveform viewers are capable of allowing the designers themselves to define the type of signal (string, integer, real number, etc.) as they want, and to edit and analyze the waveform (see, e.g., Japanese Patent Publication No. H06-342453).

In addition, in recent years, technologies for reducing power consumption of large-scale integrated circuits (LSIs) have been rapidly researched and developed. Examples of successful technologies include a multiple power-supply design. Waveform analysis in development of a circuit designed with multiple power supplies also requires analysis of power supply voltage values, in addition to analysis of logic values.

### SUMMARY

Even conventional result analyzers are becoming more user-friendly in that a waveform generated by logic simulation can be displayed in a format which the verifier defines for easier waveform analysis. However, such a result analyzer outputs only a result of logic simulation to a waveform file, and does not output the values of power supply voltage which drives the circuit. Accordingly, power supply voltage values cannot be displayed in a waveform viewer in association with respective signals, and thus both logic values and power supply voltage values cannot be simultaneously displayed in a waveform. This poses a problem in that waveform analysis needs to be performed referring to a voltage setting file, which hinders efficient analysis.

In order to solve the above problem, a simulation result analyzer according to the present invention is a simulation result analyzer for analyzing a simulation result provided by a simulator, including a waveform file extractor configured to extract waveform information of a logic simulation result, including voltage information, from the simulator, a waveform display unit configured to receive the waveform information sent from the waveform file extractor, and to process data so that a waveform can be displayed on which a voltage value in the waveform information is represented by a color, and a logic value in the waveform information is represented by a numeric value or an amplitude of a wave, and a display configured to display a waveform sent from the waveform display unit.

Such a configuration facilitates signal analysis based also on voltage information, and thus provides an advantage of efficient analysis.

With respect to the simulation result analyzer, a simulation result analyzer according to the present invention further includes a waveform file storage configured to store information from the waveform file extractor.

Such a configuration allows the wave information to be stored and used repeatedly, and thus provides an advantage of more efficient analysis.

With respect to the simulation result analyzer, a simulation result analyzer according to the present invention further includes a circuit database generator configured to receive an HDL file and a power supply information setting file used for simulation in the simulator, and to generate a circuit database including power supply information, an HDL code display unit configured to receive the circuit database, and to process data so that an HDL code can be displayed, and a circuit diagram display unit configured to receive the circuit database, and to process data so that a circuit diagram can be displayed, where the waveform file extractor extracts voltage information on each power island, and the waveform display unit receives the logic simulation result and the voltage information from the waveform file extractor and the circuit database, and processes data so that a waveform can be displayed.

Such a configuration allows the voltage values to be managed only every power island, and thus provides an advantage of reduction in the amount of data of the waveform file.

With respect to the simulation result analyzer, in a simulation result analyzer according to the present invention, the circuit database generator interprets and converts the HDL file and the power supply information setting file, and combines results based on instance information, thereby generates the circuit database in which circuit information, such as hierarchical structure information of the HDL file, is associated with power supply information described in the power supply information setting file.

Such a configuration provides an advantage in that a database can be generated in which the power supply information is associated with the circuit configuration.

Further, with respect to the simulation result analyzer, in a simulation result analyzer according to the present invention, the HDL code display unit receives the circuit database, and uses a different color for each power island when displaying a code and a hierarchical structure of the HDL file.

Such a configuration allows each of the power islands to be identified by the color also in the HDL code.

Further, with respect to the simulation result analyzer, in a simulation result analyzer according to the present invention, the circuit diagram display unit receives the circuit database, and uses a different color for each power island when displaying the circuit diagram.

Such a configuration allows each of the power islands of the circuit to be identified in the circuit diagram.

Further, with respect to the simulation result analyzer, in a simulation result analyzer according to the present invention, the waveform display unit receives the circuit database, and displays a signal driven by a clamp cell using a different color in a verification operation in which the clamp cell is virtually inserted.

Such a configuration allows a determination of whether or not the signal is driven by a clamp cell only by a waveform.

With respect to the simulation result analyzer, a simulation result analyzer according to the present invention analyzes the simulation result provided by the simulator and a power consumption measurement result provided by a power consumption measurement unit together, and after extracting the waveform information of the logic simulation result from the simulator, the waveform file extractor extracts power consumption waveform information from the power consumption measurement unit after matching a start time and a time scale thereof to a start time and a time scale of the logic simulation, and extracts waveform information after aligning the simulation waveform information and the power consumption waveform information to a same time axis.

Such a configuration allows analysis of the transition of the power supply status provided by simulation while referring to the transition of the power consumption of the actual chip, thereby allows analysis to be performed taking into account an effect of control of power supply voltage on the power consumption of the chip.

As described above, the multiple power-supply simulation result analyzers and methods of analyzing the same according to the present invention allows voltage value information to be simultaneously displayed on a waveform of conventional logic simulation, thereby allowing the man-hour of waveform analysis to be reduced.

### BRIEF DESCRIPTION OF THE DRAWINGS

FIG. 1 is a block diagram illustrating a configuration of a multiple power-supply simulation result analyzer according to the first embodiment of the present invention.

FIG. 2 is a diagram illustrating an example circuit simulated by the multiple power-supply simulation result analyzer.

FIG. 3 is a diagram illustrating an example of a waveform file including voltage value information in the multiple power-supply simulation result analyzer.

FIG. 4 is a diagram illustrating a correspondence table relating voltage values to color density levels in the multiple power-supply simulation result analyzer.

FIG. 5 is a flowchart showing operations of the waveform file extractor in the multiple power-supply simulation result analyzer.

FIG. 6 is a flowchart showing operations of the waveform display unit in the multiple power-supply simulation result analyzer.

FIG. 7 is a diagram illustrating an example of a conventional waveform display when a result of multiple power-supply simulation is analyzed.

FIG. 8 is a diagram illustrating an example of a waveform display of the multiple power-supply simulation result analyzer.

FIG. 9 is a diagram illustrating an example circuit with a level shifter removed.

FIG. 10 is a diagram illustrating an example of a waveform display when the circuit of FIG. 9 is simulated using the multiple power-supply simulation result analyzer.

FIG. 11 is a block diagram illustrating a configuration of a multiple power-supply simulation result analyzer according to the second embodiment of the present invention.

FIG. 12 is a block diagram illustrating a configuration of a multiple power-supply simulation result analyzer according to the third embodiment of the present invention.

FIG. 13 is a diagram illustrating an example of a waveform file which provides logic value information in the multiple power-supply simulation result analyzer.

FIG. 14 is a diagram illustrating an example of a waveform file which provides voltage value information in the multiple power-supply simulation result analyzer.

FIG. 15 is a diagram illustrating an example of a correspondence table relating instance names to signal names and power islands in the multiple power-supply simulation result analyzer.

FIG. 16 is a diagram illustrating an example of a tree showing the circuit configuration of the multiple power-supply simulation result analyzer.

FIG. 17 is a diagram illustrating an example circuit configuration including clamp cells which are to be analyzed by the multiple power-supply simulation result analyzer.

FIG. 18 is a flowchart showing operations of displaying a waveform of an output of a clamp cell in the multiple power-supply simulation result analyzer.

FIG. 19 is a flowchart showing operations of displaying an HDL code in the multiple power-supply simulation result analyzer.

FIG. 20 is a flowchart showing operations of displaying a circuit diagram in the multiple power-supply simulation result analyzer.

FIG. 21 is a block diagram illustrating a configuration of a multiple power-supply simulation result analyzer according to the fourth embodiment of the present invention.

FIG. 22 is a flowchart showing operations of waveform extraction and waveform file outputting in the multiple power-supply simulation result analyzer.

### DETAILED DESCRIPTION

Example embodiments of the present invention will be described below with reference to the drawings, in which the same or similar reference characters indicate the same or similar parts, and duplicate explanations for the same parts will be omitted.

### First Embodiment

In the section of the first embodiment, a multiple power-supply simulation result analyzer capable of displaying voltage information will be described.

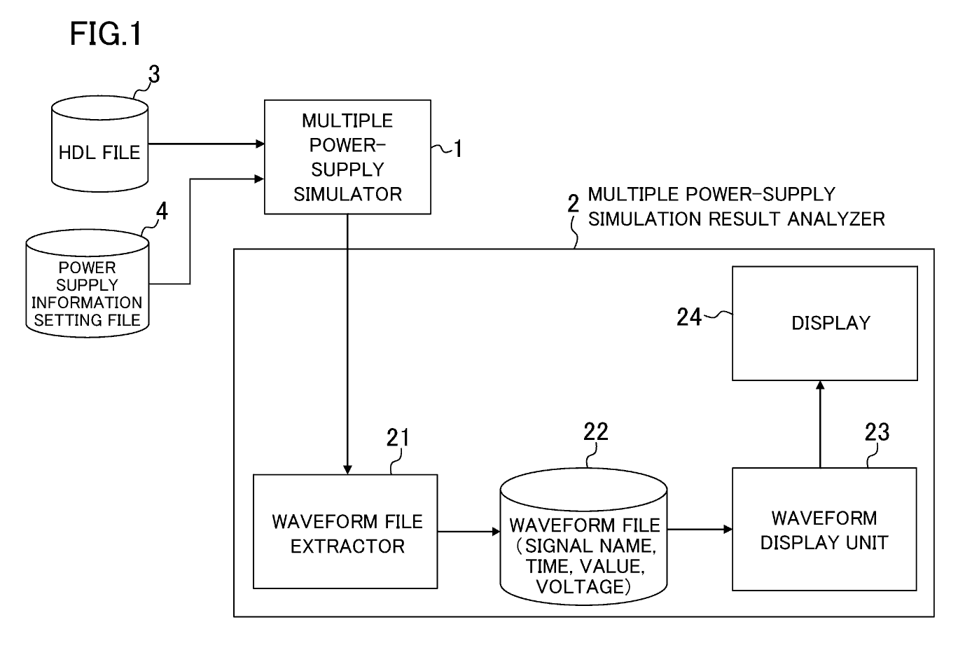

FIG. 1 is a block diagram illustrating a configuration of a multiple power-supply simulation result analyzer according to the first embodiment of the present invention.

In FIG. 1, the multiple power-supply simulation result analyzer 2 includes a waveform file extractor 21, a waveform display unit 23, and a display 24. The waveform file extractor 21 is coupled to a multiple power-supply simulator (simulator) 1, and extracts waveform information including voltage information.

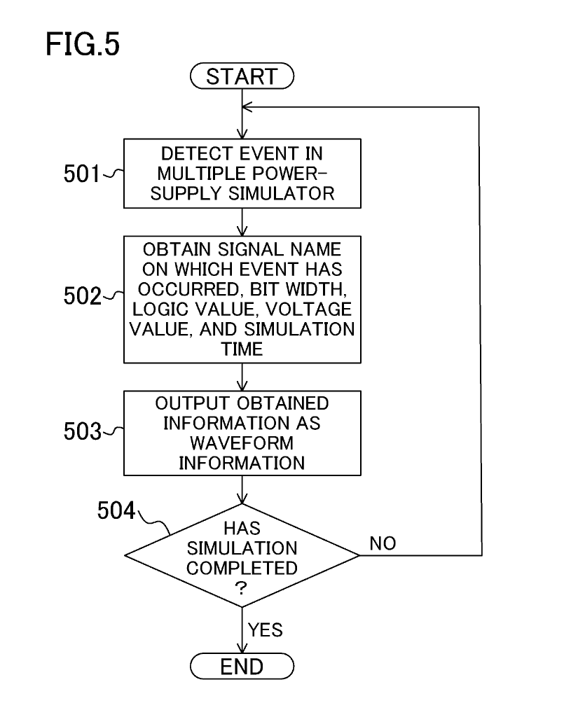

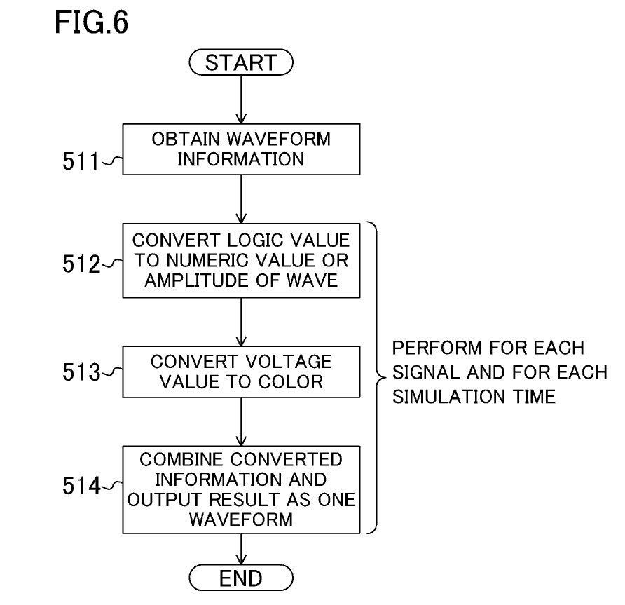

FIG. 5 is a flowchart showing operations of the waveform file extractor 21, and FIG. 6 is a flowchart showing operations of the waveform display unit 23.

Next, specific operations of the multiple power-supply simulation result analyzer of the first embodiment will be described.

The multiple power-supply simulator 1 reads both an HDL file 3 and a power supply information setting file 4, and performs a logic simulation of a multiple power-supply circuit. The waveform file extractor 21 obtains a waveform file 22, which is a result of simulation, from the multiple power-supply simulator 1, and outputs the waveform file 22 to the waveform display unit 23. In FIG. 5, the waveform file extractor 21 detects an event in the multiple power-supply simulator 1 (step 501), obtains the signal name on which the event has occurred, bit width, logic value, voltage value, and simulation time (step 502), and outputs the obtained information as waveform information (step 503). This process is iterated until the simulation completes (step 504).

In FIG. 6, the waveform display unit 23 reads the waveform file 22, and outputs a waveform to the display 24. More specifically, the waveform display unit 23 obtains the waveform information from the waveform file 22 (step 511), converts the logic value to a numeric value or an amplitude of a wave (step 512), converts the voltage value to a color (step 513), and combines the converted information and outputs the result as one waveform (step 514). Steps 512-514 are performed for each signal and for each simulation time.

The waveform file 22 includes logic values and voltage values of respective signals, and the verifier performs analysis using the waveform, including the voltage information, output on the display 24.

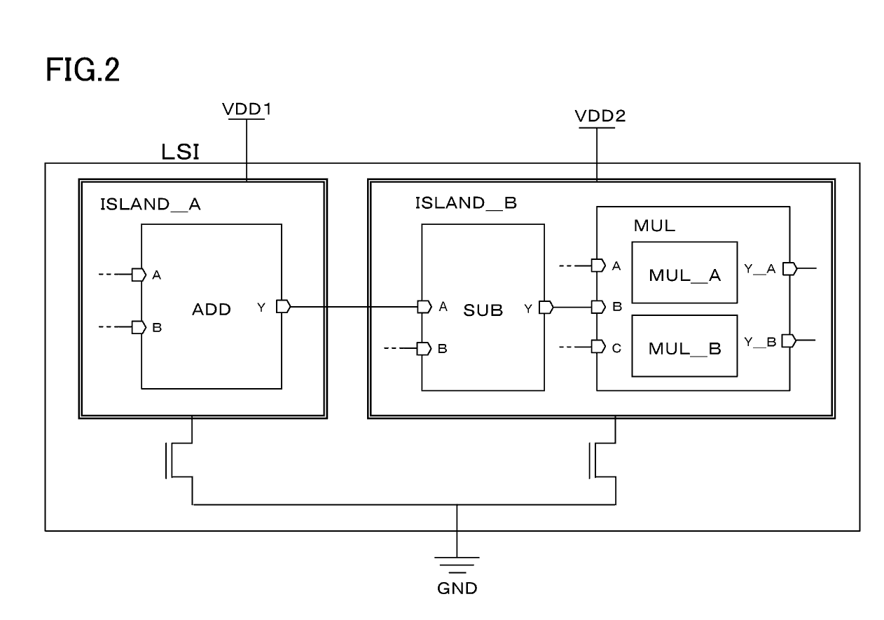

The circuit simulated by the multiple power-supply simulator 1 includes a plurality of power islands as shown in FIG. 2, and is a circuit designed with multiple power supplies, having a plurality of power supplies. Since the circuit is merely by way of example, the number of power supplies, the number and the configurations of the power islands, etc. are not intended to be restrictive.

Each time an event, such as a change in a voltage value or a change in a logic value, occurs in the multiple power-supply simulator 1, the waveform file extractor 21 obtains changed information, and outputs the changed information as the waveform file 22. The waveform file extractor 21 can obtain changed information not only at a time of event occurrence, but also every minimum time step of the multiple power-supply simulator 1. Moreover, the waveform file extractor 21 can buffer the information obtained from the multiple power-supply simulator 1.

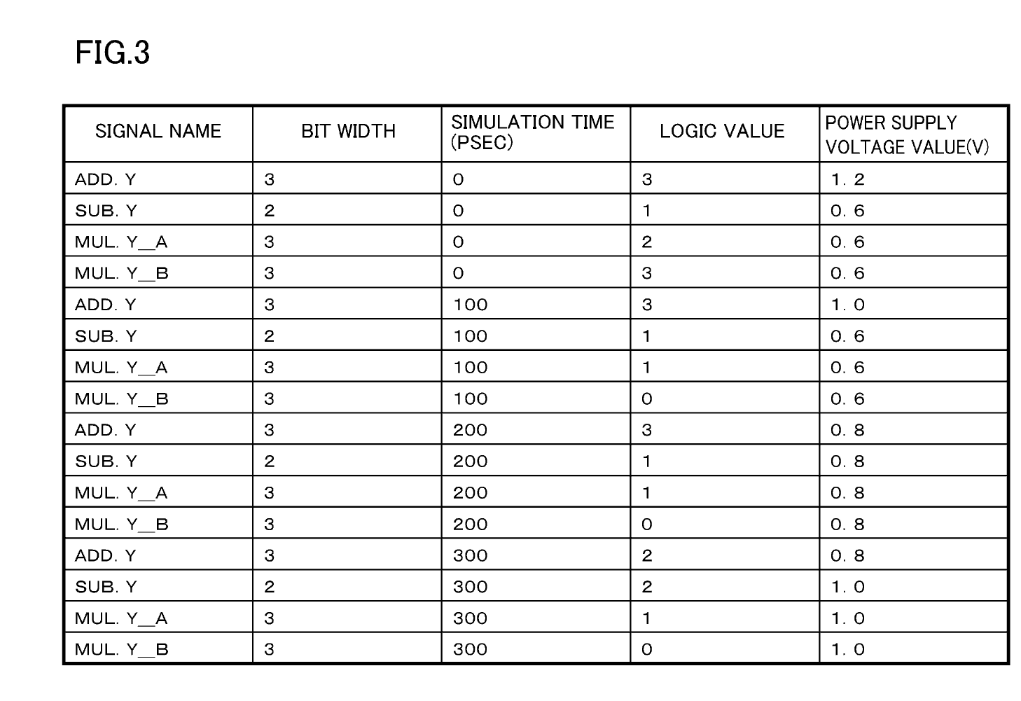

The waveform file 22 includes a table as shown in FIG. 3, and records changes of logic values and power supply voltage values of respective signals in a temporal order. The information of power supply voltage values is newly added in the present invention. The table of FIG. 3 is merely by way of example, and the order and the items of the information are not intended to be restrictive.

The waveform display unit 23 outputs a waveform in which the color density changes depending on a change in voltage value as shown in FIG. 3. For example, the voltage level can be displayed such that a higher voltage is expressed by a deeper color. Moreover, the display of the color density is not limited to be monochromatic. For example, by using a reddish color for a higher voltage, and using a bluish color for a lower voltage, the voltage levels can be expressed. In addition, the waveform can express the voltage value by a pattern, by the amplitude, or by the font size used to show the logic value, in addition to the color density.

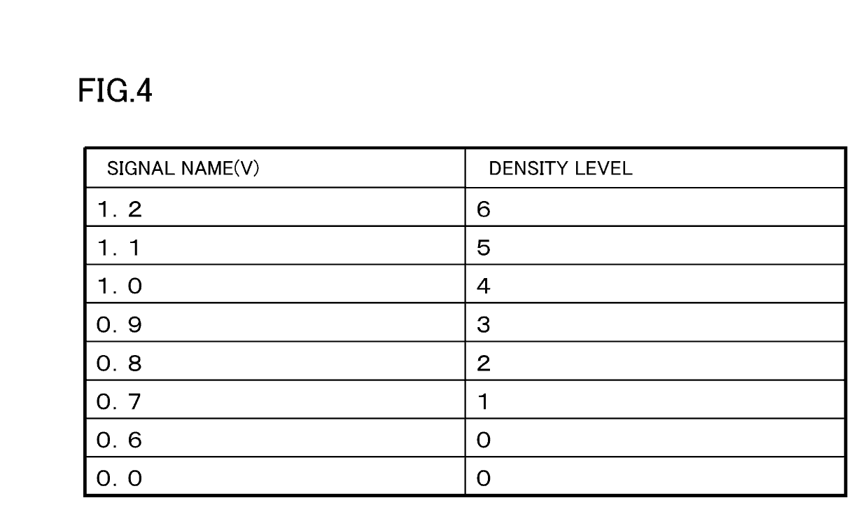

Furthermore, the waveform display unit 23 includes a table as shown as FIG. 4, converts the power supply voltage values in the waveform file 22 into color density levels, and outputs the color density levels to the display 24. The voltage values are expressed not only by color density, and thus a correspondence table relating a voltage value to a pattern is used when the voltage values are expressed by a pattern; a correspondence table relating a voltage value to the amplitude, when expressed by the amplitude; and a correspondence table relating a voltage value to a font size, when expressed by a font size.

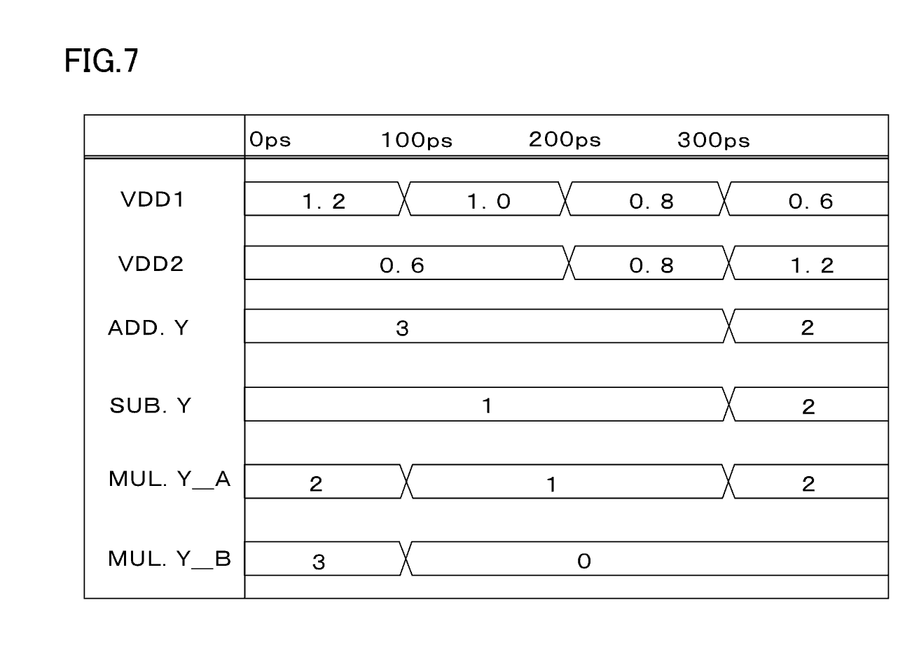

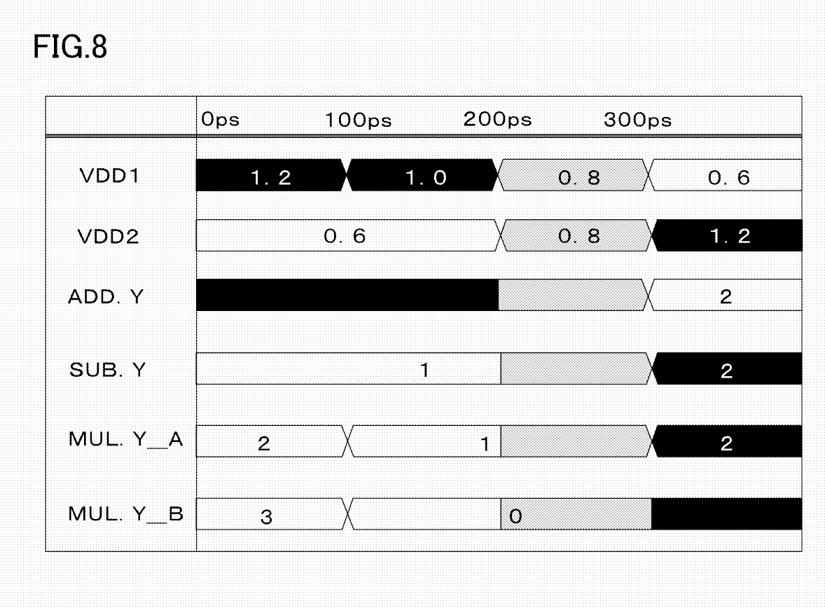

Thus, according to the first embodiment, the power supply voltage values can also be displayed simultaneously in the signal simulation result. Therefore, while the power supply voltage values cannot be identified only by a waveform as shown in FIG. 7 which shows a conventional technology, the power supply voltage values can be identified only by a waveform as shown in FIG. 8, thereby facilitating signal analysis, and thus an advantage of efficient analysis is provided.

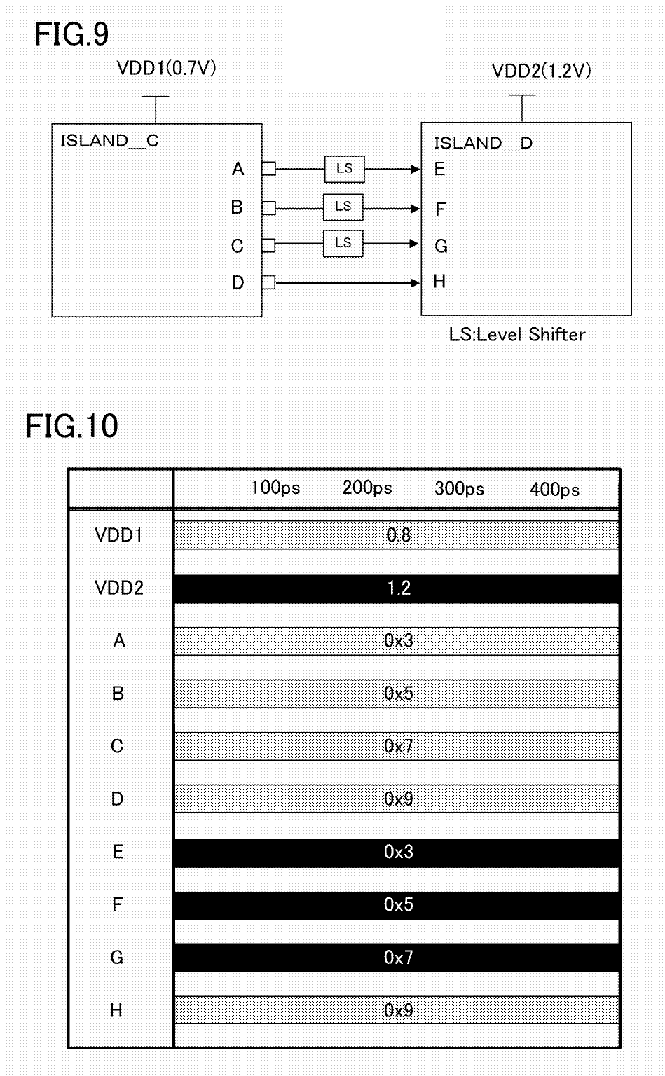

Similarly, according to the first embodiment, displaying a waveform of a circuit with a part of level shifters LS removed as shown in FIG. 9 results in a waveform display as shown in FIG. 10, and thus it can be known only from this waveform display that the level shifter for a signal H is removed. As such, the first embodiment provides the advantage of efficient analysis also with respect to a failure of a removed level shifter.

### Second Embodiment

Next, in the section of the second embodiment, another multiple power-supply simulation result analyzer capable of displaying voltage information will be described.

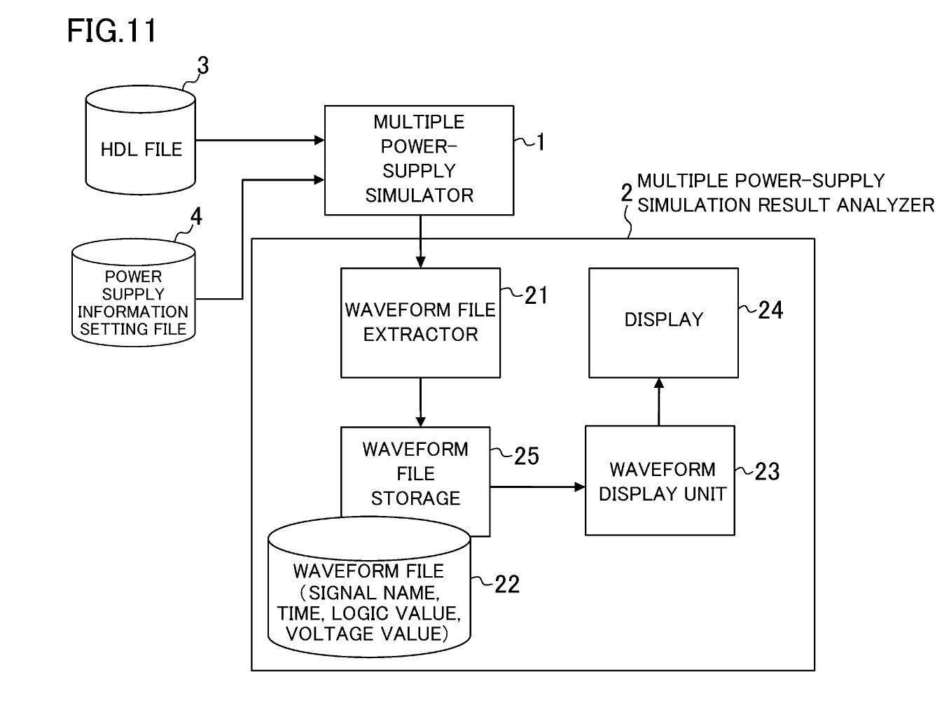

FIG. 11 is a block diagram illustrating a configuration of a multiple power-supply simulation result analyzer according to the second embodiment of the present invention. The configuration of FIG. 11 further includes a waveform file storage 25 with respect to the configuration of the first embodiment.

Next, specific operations of the multiple power-supply simulation result analyzer of the second embodiment will be described.

The multiple power-supply simulator 1 reads both an HDL file 3 and a power supply information setting file 4, and performs a logic simulation of a multiple power-supply circuit. The waveform file extractor 21 obtains a result of simulation from the multiple power-supply simulator 1, and outputs a waveform file 22 to the waveform display unit 23. The waveform display unit 23 reads the waveform file 22, and outputs a waveform to the display 24. The waveform file 22 includes voltage information, and the verifier performs analysis using the waveform, including the voltage information, output on the display 24. Voltage values can be displayed in the same manner as that of the first embodiment.

Thus, according to the second embodiment, the voltage information can also be displayed simultaneously in the signal simulation result. Therefore, this embodiment provides not only an advantage of efficient analysis by facilitating signal analysis, but also an advantage of more efficient analysis by the capability of iterative analysis because the waveform file storage 25 stores the waveform file 22.

### Third Embodiment

Next, in the section of the third embodiment, another multiple power-supply simulation result analyzer capable of displaying voltage information will be described.

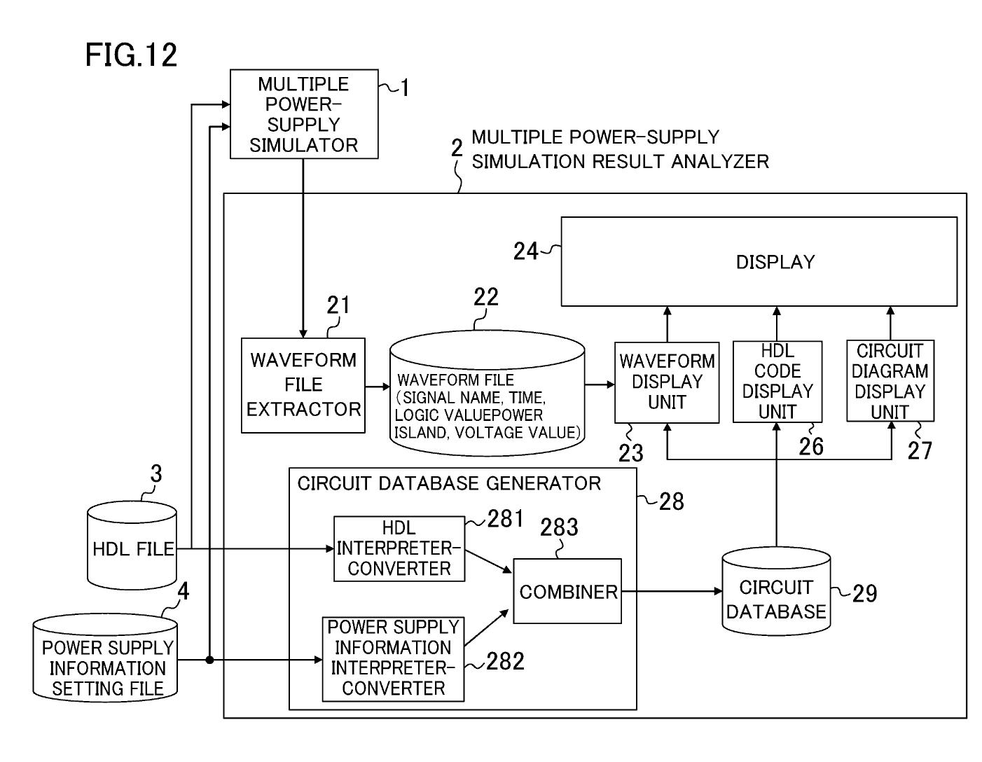

FIG. 12 is a block diagram illustrating a configuration of a multiple power-supply simulation result analyzer according to the third embodiment of the present invention.

In the configuration of FIG. 12, the waveform file 22, output from the waveform file extractor 21 to the waveform display unit 23, records the voltage values of respective power islands as compared to the configuration of the first embodiment, in which the waveform file 22 records the voltage values of respective signals. Moreover, the configuration of FIG. 12 further includes a circuit database generator 28, an HDL code display unit 26, and a circuit diagram display unit 27.

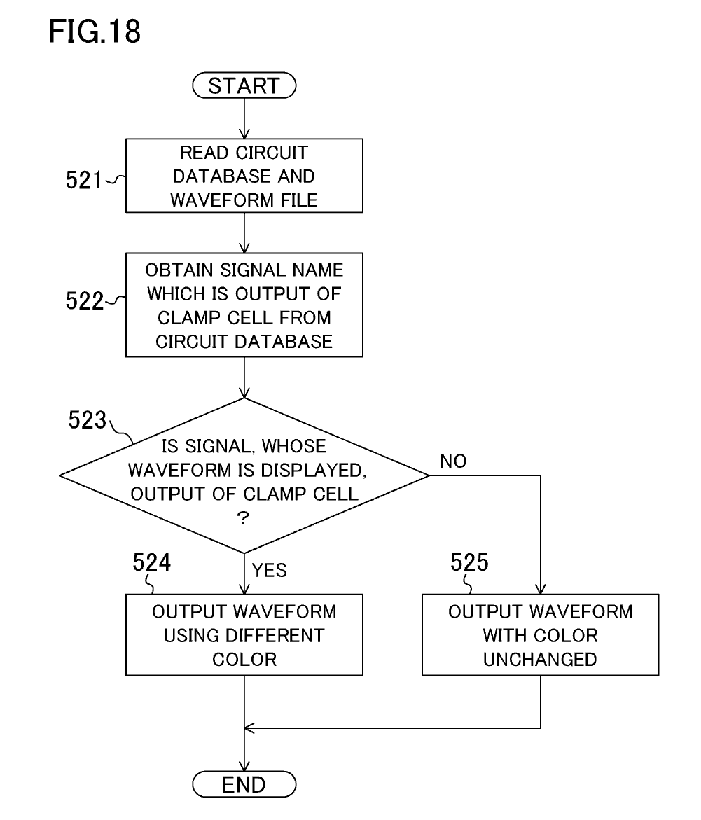

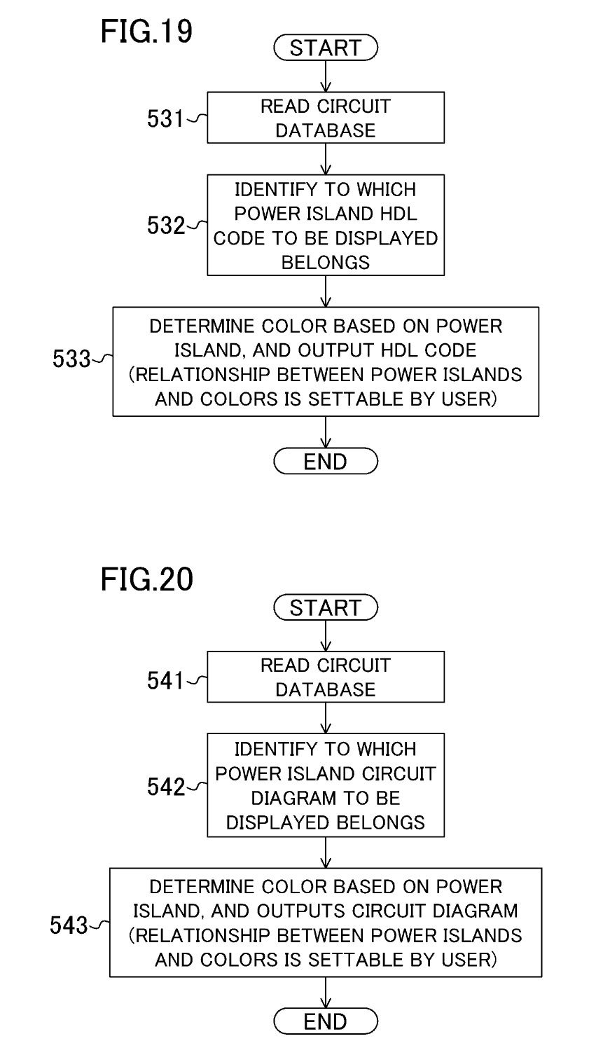

FIG. 18 is a flowchart showing operations of displaying a waveform of an output of a clamp cell in the waveform display unit 23. FIG. 19 is a flowchart showing operations of the HDL code display unit 26. FIG. 20 is a flowchart showing operations of the circuit diagram display unit 27.

Next, specific operations of the multiple power-supply simulation result analyzer of the third embodiment will be described.

The multiple power-supply simulator 1 reads both an HDL file 3 and a power supply information setting file 4, and performs a logic simulation of a multiple power-supply circuit.

The waveform file extractor 21 obtains a result of simulation from the multiple power-supply simulator 1, and outputs, to the waveform display unit 23, the waveform file 22 having a table (signal waveform file) which records times and logic values of respective signals, and a table (power supply waveform file) which records times and voltage values of respective power islands.

The circuit database generator 28 includes an HDL interpreter-converter 281, a power supply information interpreter-converter 282, and a combiner 283. The circuit database generator 28 receives both the HDL file 3 and the power supply information setting file 4, the HDL interpreter-converter 281 interprets and converts the HDL file 3, the power supply information interpreter-converter 282 interprets and converts the power supply information setting file 4, and the combiner 283 associates circuit information described in the HDL file 3 with power supply information described in the power supply information setting file 4, and outputs a circuit database 29.

The waveform display unit 23 reads the waveform file 22 having both the signal waveform file and the power supply waveform file, and the circuit database 29, and outputs a waveform, including voltage information, to the display 24. In a verification operation of virtual power shutdown in which a clamp cell is virtually inserted, the waveform display unit 23 uses a different color for the signal output from the clamp cell A or B inserted in the circuit as shown in FIG. 17, and displays the result on the display 24. Note that the circuit shown in FIG. 17 is merely by way of example, and the circuit configuration around the clamp cell A or B, and the type of the cell used as the clamp cell A or B are not intended to be restrictive.

More specifically, as shown in FIG. 18, the waveform display unit 23 reads the circuit database 29 and the waveform file 22 (step 521), obtains a signal name which is the output of the clamp cell A or B from the circuit database 29 (step 522), determines whether or not the signal whose waveform is displayed is either the output of the clamp cell A or B (step 523), and outputs a waveform using a different color if the output is that of the clamp cell A or B (step 524), and using the color unchanged if the output is neither that of the clamp cell A nor B (step 525). The verifier performs analysis using the waveform output on the display 24. Voltage values can be displayed in the same manner as that of the first embodiment.

As shown in FIG. 19, the HDL code display unit 26 reads the circuit database 29, and outputs an HDL code using a different color for each power island to the display 24. More specifically, the HDL code display unit 26 reads the circuit database 29 (step 531), identifies to which power island the HDL code to be displayed belongs (step 532), determines a color based on the power island, and outputs the HDL code (step 533). The verifier performs analysis using the HDL code output on the display 24. In addition, the relationship between the power islands and the colors of the HDL code can be set by the verifier.

As shown in FIG. 20, the circuit diagram display unit 27 reads the circuit database 29, and outputs a circuit diagram using a different color for each power island to the display 24. More specifically, the circuit diagram display unit 27 reads the circuit database 29 (step 541), identifies to which power island the circuit diagram to be displayed belongs (step 542), determines a color based on the power island, and outputs the circuit diagram (step 543). The verifier performs analysis using the circuit diagram output on the display 24. In addition, the relationship between the power islands and the colors of the circuit diagram can be set by the verifier.

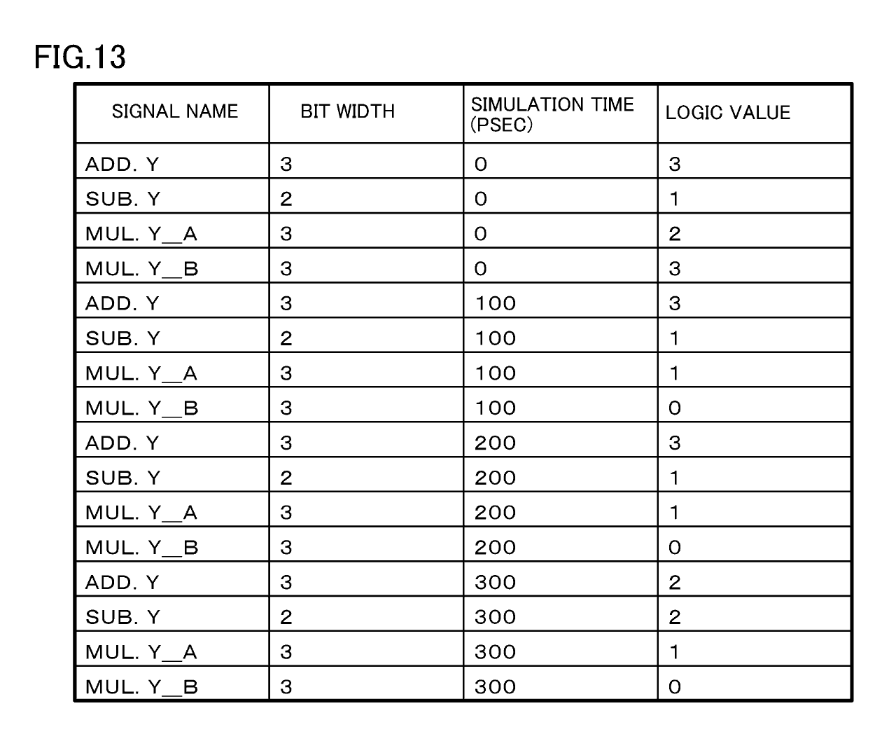

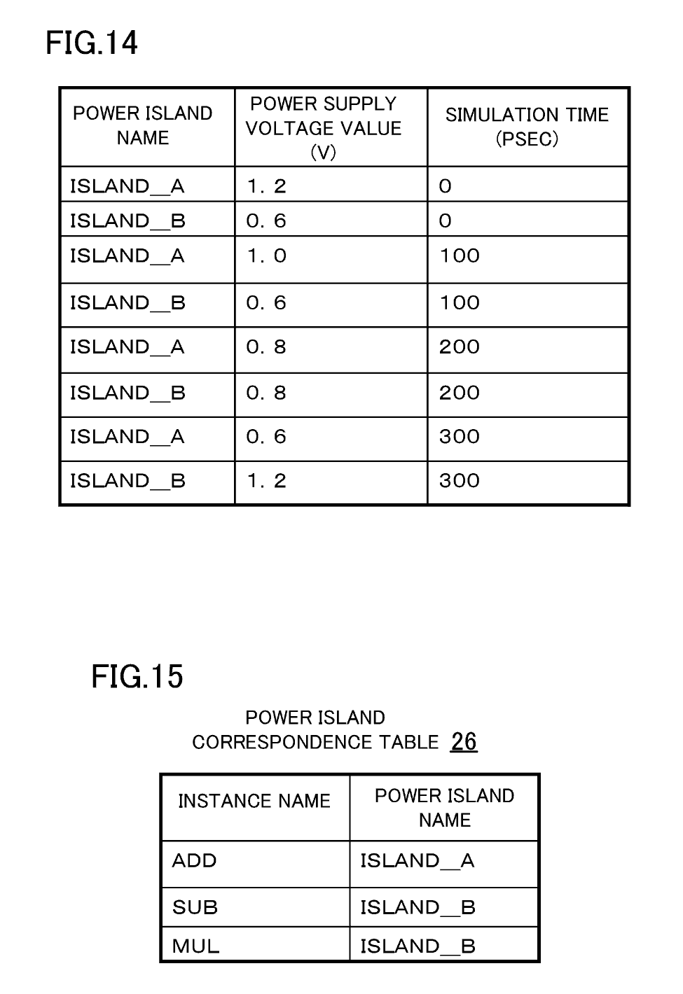

The waveform file 22 includes the tables as shown in FIGS. 13 and 14, and records voltage values of respective power islands, instead of those of respective signals as in the table of FIG. 3 used in the first embodiment. The logic values are recorded for respective signals as shown in FIG. 13 similarly to the first embodiment. In addition, the relationship among the power islands, the instance names, and the signal names is stored in a power island correspondence table 26 as shown in FIG. 15. The power island correspondence table 26 is not generated for each simulation, and requires no changes as long as the circuit remains unchanged. The tables of FIGS. 13, 14, and 15 are merely by way of example, and the orders and the formats of the information are not intended to be restrictive.

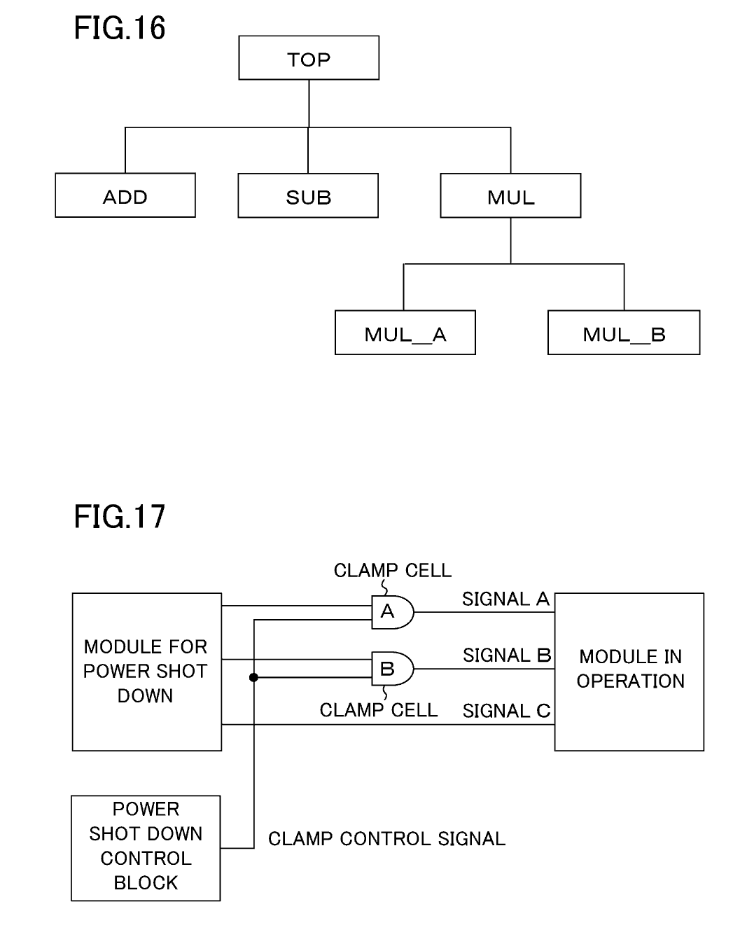

The circuit database 29 stores the circuit configuration in a tree structure as shown in FIG. 16, and stores the power island configuration in a table as shown in FIG. 15, thereby associates the modules with the power islands. Moreover, a module with which no power island is associated in a table as shown in FIG. 15 is stored as a module which belongs to a power island in a higher hierarchical level. The tree structure of FIG. 16 is merely by way of example, and the order and the format of the information are not intended to be restrictive.

Thus, according to the third embodiment, the waveform file extractor 21 does not need to acquire voltage value information for each signal, but only needs to output the voltage values of respective power islands to the waveform file 22, thereby allowing the amount of processing of the waveform file extractor 21 to be reduced, and thus an advantage of reduction in the processing time is provided. Moreover, reduction in the amount of information allows the size of the waveform file 22 to be reduced, and thus an advantage of reduction in the capacity of the storage unit is provided.

In waveform analysis, the waveform of the signal driven by the clamp cell A or B is displayed using a different color, and thus it can be determined only by the color of the waveform whether or not the signal is driven by either the clamp cell A or B, thereby allowing efficient analysis.

### Fourth Embodiment

Next, in the section of the fourth embodiment, another multiple power-supply simulation result analyzer capable of displaying voltage information will be described.

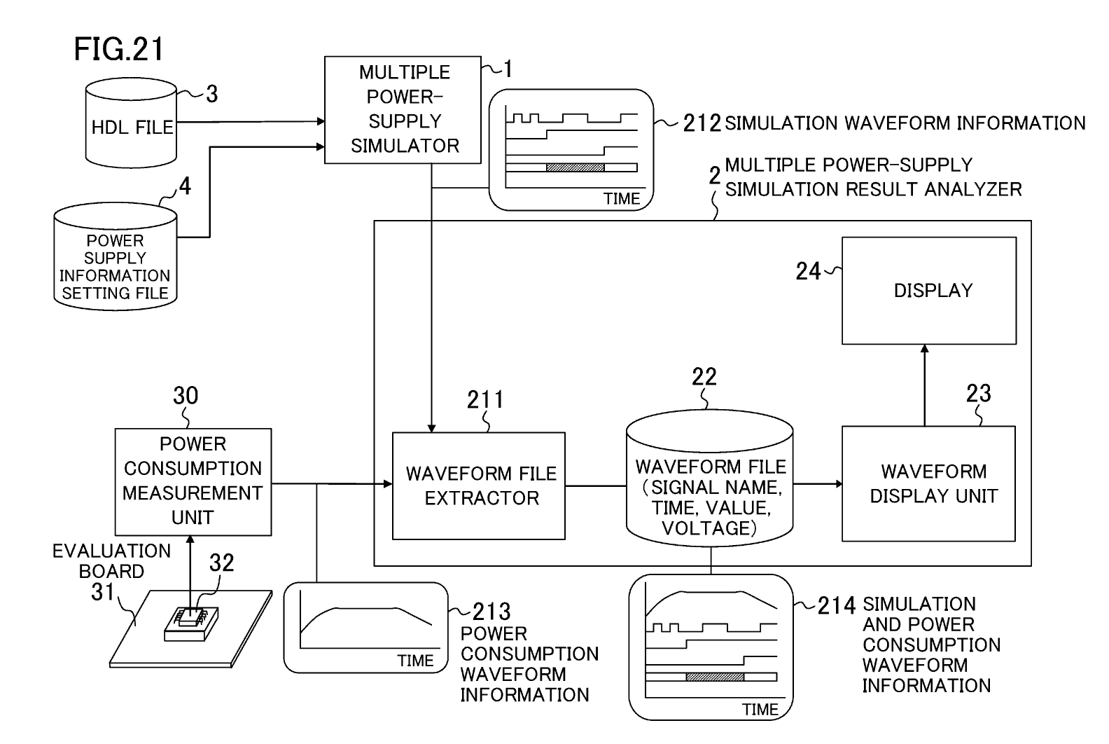

FIG. 21 is a block diagram illustrating a configuration of a multiple power-supply simulation result analyzer according to the fourth embodiment. The configuration of FIG. 21 may be applied to any of the first through third embodiments, and by way of example, differs from that of the first embodiment in that a power consumption measurement unit 30 is added and a waveform file extractor 211 is used in place of the waveform file extractor 21.

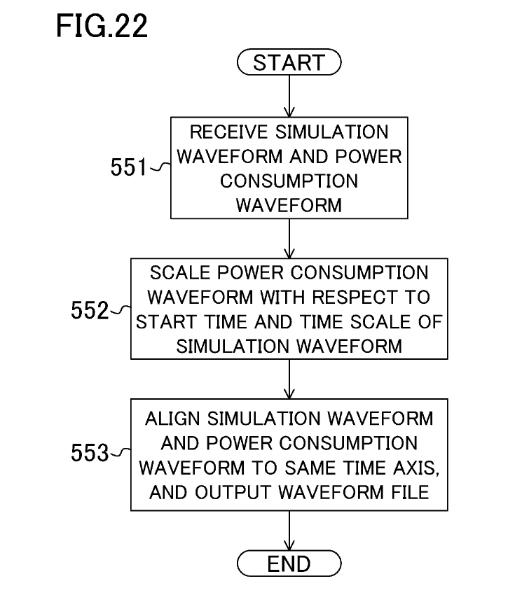

FIG. 22 is a flowchart showing operations of the waveform file extractor 211.

Next, specific operations of the multiple power-supply simulation result analyzer of the fourth embodiment will be described.

The multiple power-supply simulator 1 reads both an HDL file 3 and a power supply information setting file 4, and performs a logic simulation of a multiple power-supply circuit.

The power consumption measurement unit 30 operates, using a same simulation pattern as that used in the multiple power-supply simulator 1, an evaluation board 31 which mounts a chip 32 generated based on the HDL file 3 used for a simulation by the multiple power-supply simulator 1, and measures the power consumption of the chip 32.

The waveform file extractor 211 obtains both simulation waveform information 212 from the multiple power-supply simulator 1, and power consumption waveform information 213 from the power consumption measurement unit 30 (step 551), scales the power consumption waveform so that the time scale and the start time thereof match the start time and the time scale of the simulation waveform (step 552), and aligns the simulation waveform and the power consumption waveform to a same time axis, and outputs the result as one waveform file 22 (step 553). The waveform display unit 23 reads the waveform file 22, and outputs a waveform to the display 24. The waveform file 22 includes voltage information, and the verifier performs analysis using the waveform, including the voltage information, output on the display 24. Voltage values can be displayed in the same manner as that of the first embodiment.

It is assumed that the multiple power-supply simulator 1 and the power consumption measurement unit 30 are inputs which cause a same operation.

Thus, according to the fourth embodiment, the signal simulation result can display not only the voltage information simultaneously but also the power consumption waveform of an actual chip. This facilitates not only signal analysis, but also observation of an effect of control on a signal or the voltage on the change in the power consumption of an actual chip, and thus provides an advantage of efficient analysis. In particular, if chip development using the HDL file 3 progresses, and the operation of a prototype chip is verified using the evaluation board, an internal state of the chip presented by a simulation and the power consumption of the chip can be both observed.

Although, in the first through fourth embodiments, the multiple power-supply simulation result analyzers and methods of analyzing the same have been described as intended for simulating a multiple power-supply circuit, the application is not limited to an analyzer for a multiple power-supply circuit. It is to be understood that the analyzers and methods provide similar advantages as long as the voltage value of a signal has multiple values.

As described above, the present invention is useful for circuit verification, and more particularly is useful as an EDA tool which verifies a logic circuit designed with multiple power supplies.

What is claimed is:

1. A simulation result analyzer for analyzing a simulation result provided by a simulator, comprising:
a waveform file extractor configured to extract waveform information of a logic simulation result, including voltage information, from the simulator;
a waveform display unit configured to receive the waveform information sent from the waveform file extractor, and to process data so that a waveform can be displayed on which a voltage value in the waveform information is represented by a color, and a logic value in the waveform information is represented by a numeric value or an amplitude of a wave; and
a display configured to display a waveform sent from the waveform display unit.

2. The simulation result analyzer of claim 1, further comprising:
a waveform file storage configured to store information from the waveform file extractor.

3. The simulation result analyzer of claim 1, comprising:
a circuit database generator configured to receive a hardware description language (HDL) file and a power supply information setting file used for simulation in the simulator, and to generate a circuit database including power supply information;
an HDL code display unit configured to receive the circuit database, and to process data so that an HDL code can be displayed; and
a circuit diagram display unit configured to receive the circuit database, and to process data so that a circuit diagram can be displayed,
wherein
the waveform file extractor extracts voltage information on each power island, and
the waveform display unit receives the logic simulation result and the voltage information from the waveform file extractor and the circuit database, and processes data so that the waveform can be displayed.

4. The simulation result analyzer of claim 3, wherein
the circuit database generator interprets and converts the HDL file and the power supply information setting file, and combines results based on instance information, thereby generates the circuit database in which circuit information, such as hierarchical structure information of the HDL file, is associated with power supply information described in the power supply information setting file.

5. The simulation result analyzer of claim 3, wherein
the HDL code display unit receives the circuit database, and uses a different color for each power island when displaying a code and a hierarchical structure of the HDL file.

6. The simulation result analyzer of claim 3, wherein
the circuit diagram display unit receives the circuit database, and uses a different color for each power island when displaying the circuit diagram.

7. The simulation result analyzer of claim 3, wherein
the waveform display unit receives the circuit database, and displays a signal driven by a clamp cell using a different color in a verification operation in which the clamp cell is virtually inserted.

8. The simulation result analyzer of claim 1, wherein
the simulation result analyzer analyzes the simulation result provided by the simulator and a power consumption measurement result provided by a power consumption measurement unit together, and
after extracting the waveform information of the logic simulation result from the simulator, the waveform file extractor extracts power consumption waveform information from the power consumption measurement unit after matching a start time and a time scale thereof to a start time and a time scale of the logic simulation, and extracts waveform information after aligning the simulation waveform information and the power consumption waveform information to a same time axis.

9. A method of analyzing a simulation result for analyzing and displaying a signal from a simulator, comprising:
extracting waveform information of a logic simulation result, including voltage information, from the simulator;
receiving the waveform information extracted in the extracting, and processing data so that a waveform can be displayed on which a voltage value in the waveform information is represented by a color, and a logic value in the waveform information is represented by a numeric value or an amplitude of a wave; and
displaying a waveform sent in the processing.

10. The method of analyzing a simulation result of claim 9, further comprising:
storing information extracted in the extracting.

11. The method of analyzing a simulation result of claim 9, comprising:
receiving an HDL file and a power supply information setting file used for simulation in the simulator, and generating a circuit database including power supply information;
receiving the circuit database, and processing data so that an HDL code can be displayed; and
receiving the circuit database, and processing data so that a circuit diagram can be displayed,
wherein
the extracting extracts voltage information on each power island, and
the receiving and processing data so that a waveform can be displayed receives the logic simulation result and the voltage information extracted in the extracting and the circuit database, and processes data so that the waveform can be displayed.

12. The method of analyzing a simulation result of claim 11, wherein
the receiving and generating interprets and converts the HDL file and the power supply information setting file, and combines results based on instance information, thereby generates the circuit database in which circuit information, such as hierarchical structure information of the HDL file, is associated with power supply information described in the power supply information setting file.

13. The method of analyzing a simulation result of claim 11, wherein
the receiving and processing data so that an HDL code can be displayed receives the circuit database, and uses a different color for each power island when displaying a code and a hierarchical structure of the HDL file.

14. The method of analyzing a simulation result of claim 11, wherein
the receiving and processing data so that a circuit diagram can be displayed receives the circuit database, and uses a different color for each power island when displaying a circuit diagram.

15. The method of analyzing a simulation result of claim 11, wherein
the receiving and processing data so that a waveform can be displayed receives the circuit database, and displays a signal driven by a clamp cell using a different color in a verification operation in which the clamp cell is virtually inserted.

16. The method of analyzing a simulation result of claim 9, wherein
the method of analyzing a simulation result is a method of analyzing the simulation result provided by the simulator and a power consumption measurement result provided by a power consumption measurement unit together, and
after extracting the waveform information of the logic simulation result from the simulator, the extracting extracts power consumption waveform information from the power consumption measurement unit after matching a start time and a time scale thereof to a start time and a time scale of the logic simulation, and extracts waveform information after aligning the simulation waveform information and the power consumption waveform information to a same time axis.
